(19) United States
(12) Patent Application Publication
(10) Pub. No.: US 2026/0004601 A1
(43) Pub. Date: Jan. 1, 2026

(54) READING OPTICAL CODES

(71) Applicant: SICK AG, Waldkirch (DE)

(72) Inventors: Pascal SCHÜLER, Waldkirch (DE); Steffen ZOPF, Waldkirch (DE)

(21) Appl. No.: 19/196,999

(22) Filed: May 2, 2025

(30) Foreign Application Priority Data
Jun. 27, 2024 (EP) 24184916.5

(51) Int. Cl. G06V 30/19; G06V 10/74; G06V 10/774; G06V 30/14; G06V 30/30

(52) U.S. Cl. CPC G06V 30/19007; G06V 10/74; G06V 10/774; G06V 30/1437; G06V 30/19147; G06V 30/30

(57) ABSTRACT

A method of reading an optical code is provided that encodes a message that has a character chain having a plurality of characters, said method comprising the steps: of recording image data having the optical code; evaluating the image data by reading the message; comparing the read characters of the message with at least one scheme that contains a character for at least one position of the message that is expected at this position in codes to be read; and checking or correcting the read message based on a scheme matching the message after the comparison. A prefabricated catalog of schemes is provided here and a subset of the schemes of the catalog is activated for the comparison with the read characters of the message.

The invention relates to a method of reading optical codes and to a corresponding optoelectronic code reader.

Code readers are known from supermarket checkouts, for automatic parcel identification, for sorting mail shipments, from baggage handling at airports, and from other logistics applications. In a code scanner, a reading beam is guided transversely over the code by means of a rotating mirror or by means of a polygon mirror wheel. A camera-based code reader takes images of the objects having the codes located thereon with the aid of an image sensor and image evaluation software extracts the code information from these images.

In an important application group, the objects bearing the code are conveyed past the code reader. A scanning code reader here detects the respective codes successively led into its reading zone. Alternatively, in a camera based code reader, a line scan camera reads the object images having the code information successively and linewise with the relative movement. As a rule, image data are recorded using a two-dimensional image sensor that overlap more or less depending on the recording frequency and on the conveying speed. So that the objects can be arranged in any desired orientation on the conveyor, a plurality of code readers are often provided at a reading tunnel to record objects from a plurality of sides or from all sides. A scanning code reader also detects the remission and thus ultimately image lines that can be assembled to form an object image, even though an image sensor is preferred for this purpose in practice.

Code zones can be identified in such an object field and one-dimensional or two-dimensional codes can be read.

One of the most important quality criteria for a code reader or for a reading tunnel is a high reading rate. Reading errors make complex error remedies necessary such as the repeat manual scanning or a resorting. The cause for such errors can lie in the quality of the code itself, in an unfavorable reading situation, for example with a code under a film that causes reflections, and finally also in evaluation errors, for instance as part of the binarization of gray scale values or in the form of imprecisely calculated scanning positions.

A method of reading an optical code is advanced in EP 3 428 835 B1 in which a code word is replaced with a code word known for a position at at least one position of the code in a pre-correction. The known code words are parameterized, are specified by a database of a higher ranking system, or are taught from a history of read codes.

EP 4 258 160 A1 expands this idea and introduces so-called schemes. Expectations of frequently occurring code constellations are formalized in a scheme, for example as regular expressions. Analogously to EP 3 428 835 B, there is a fixed portion here that corresponds to a fixed sequence of characters recurring in a large number of codes and a variable portion that detects more general rules such as that only numerals or only letters occur at specific positions. Schemes can be used to recognize a message read from an optical code as read incorrectly or to correct it.

The requirement for such a correction is a list of schemes, in particular in the form of regular expressions that matches the optical codes frequently occurring in an application. This represents a great obstacle in practice. The preparation of the list does not only require a substantial effort, but is also additionally prone to error because the organizer as a rule has little understanding of the syntax of regular expressions and also does not know the frequently occurring codes and would only be able to discover them laboriously with the aid of logfiles. The consequence is that the list remains incomplete and thus potential for corrections is lost or even that defective schemes are used that also artificially generate additional reading errors.

It is therefore the object of the invention to provide an even more reliable and more robust method of reading optical codes.

This object is satisfied by a method of reading optical codes and by a corresponding optoelectronic code reader in accordance with the respective independent claim. The optical code contains a message, that is that clear text that should be communicated by the optical code and that is encoded therein. The message has a character chain having a plurality of characters. It preferably also includes at least one check character, for example a checksum, in addition to the utility character. To read the code and thus the message, image data having the optical code are first recorded in one of the known manners described in the introduction. Code zones that segment the image data, for example based on the contrast, are then preferably located in the image data by a pre-processing and the respective code in the code zones is decoded and the message thereby read.

The read characters of the message are compared with at least one scheme. The scheme expects a specific character at a plurality of positions of the message. Whether the scheme matches the message is determined by a comparison of the read characters of the message at these positions with the characters of the scheme. For this purpose, there must in particular be agreement for a minimum portion of the characters expected by the scheme with the read characters of the message, for example for at least two, at least three, at least four, or even more characters or for a minimum portion of the characters expected from the scheme such as at least a third or at least half. If this is the case, a check or correction of the message from scheme takes place, in particular additional tests of the message are performed or information on the code and the message are derived for a check based on the scheme and/or characters of the scheme are taken over into the read message for a correction, preferably all of the characters expected by the scheme. A correction with the schemes preferably does not take place when the optical code could anyway be read without error (GoodRead) since it is the aim of the correction to still avoid a reading error wherever possible; this is not necessary if there are no reading errors at all. Up to this point, the method is based on EP 3 428 835 B1 and EP 4 258 160 A1 to which reference is additionally made for further details and possible embodiments.

The invention starts from the basic idea that scheme used for the comparison and the correction are selected from a pool or catalog of prefabricated schemes. The schemes in the catalog can use higher ranking knowledge, can be prepared and tested by experts, and they are therefore better adapted and more reliable than schemes configured in the field by an organizer or automatically detected schemes. Certain schemes of the catalog are released or activated in a respective code reading application. A subset of the catalog is thus actually used, with a subset as usual being able to include one or some schemes of the catalog. The borderline cases that no schemes at all and/or that all the schemes have been activated can be precluded, but the procedure is also different to the previous than to date in these borderline cases because the borderline case has then been directly configured and this possibility was also not previously present.

It must be stated as a precaution that it is an automatically running process that is in particular implemented on a computer. The preparation of the catalog of schemes is here not part of the method in accordance with the invention that rather requires such a catalog as given or prefabricated. To complete the catalog in advance, any desired mixture of manual and computer aided steps can be carried out; for example suggestions of an automatic process that an expert adopts or revises; conversely, schemes of an expert that a computer completes, and the like.

The invention has the advantage that schemes matching the code situation or application can be used. The correctness can be ensured for all the schemes of the catalog in advance, for example ex works or by experts and equally relevant schemes are also present for the frequently occurring optical codes. Incorrect schemes that only generate reading errors can be precluded from the start. Exactly those schemes from the qualitatively high grade catalog are used that are required for the codes to be read due to the activation. Special knowledge or also only a time effort in the putting into operation are no longer required. If required, new schemes can be added to the catalog to expand the spectrum of possible applications.

A scheme can have a fixed portion having at least one fixed character and/or a variable portion having at least one variable character. The possible properties described here and in the following relate to at least one scheme or to a plurality of schemes up to all the schemes of the catalog. Which character should be at the associated position of the message is known with a fixed character. On the other hand, a variable character is not set to a fixed character and can vary in a partial range of the total possible characters. Typical examples for a variable character are numerals or letters. A scheme, for example, therefore does not fit in a variable character that expects a letter, but finds a numeral. In accordance with their definition, fixed characters and variable characters preclude one another.

A scheme preferably has a code length and/or contains a fixed character or a variable character for every position. The scheme thus includes information on the code length, the total number of characters of the message. The scheme is preferably complete; which fixed character is there or which partial range of possible characters is possible as a variable character there is therefore known from the scheme for each position of the message. The code length or a code length interval that can, however, nevertheless additionally be explicit parameters of the scheme is implicit in this completeness. A scheme can also be incomplete; there is then at least one completely free character in the limits of the general code specification. This can in particular be a temporary state during a teaching of a scheme.

A scheme preferably has at least one of the following partial ranges of the possible characters of a variable character: non-printable characters, special characters, numerals, letters, lower case letters, upper case letters. These are particularly suitable examples for divisions or classes of the characters conceivable in a message. The division could take place completely at random in principle. Such semantic classes, however, facilitate the understanding of the user so that the use can be diagnosed and optimized more easily. In addition, regularities in codes are likewise rather to be found in the form of semantic classes as any desired divisions in practice. The possible characters of a code are frequently represented by numbers 0 . . . 127 of the ASCII code. Said partial portions can be found in the ASCII code again.

A scheme is preferably formulated as a regular expression that indicates the permitted characters for the respective positions. A regular expression makes it easier for the user to understand and optionally edit the scheme. The internal processing is simultaneously facilitated and the error susceptibility on the programming of the decoders is reduced. Alternatively, a proprietary definition of schemes is conceivable that, however, at least approximately reaches the clarity and formal regularity of regular expressions.

The schemes of the subset are preferably activated in a teaching phase. This teaching phase is prior to the actual operation or the code reading application still works without schemes for a time during the teaching phase. The length of the teaching phase can be parameterizable. A weighing must take place here between the waiting time up to the activation of the matching schemes and the quality of the fit between the activated schemes and the application.

When a message of an optical code was able to be read, a comparison of the read characters of the message with the schemes of the catalog preferably takes place to determine which scheme matches the read message and a statistic is built up from the matching messages, in particular a histogram that collects the frequencies of the matching messages. The schemes of the catalog are thus applied to a read message in the teaching phase independently of an activation still absent at this point in time. It is not yet a question of correcting the message. This would not be sensible at all because only read messages (GoodReads) are first selectively evaluated with the schemes. It is a question of collecting information on which optical codes occur how frequently in the current application situation and which schemes could accordingly be relevant. This information is collected in a statistic, either initially simply as datasets such as (point in time; message; matching scheme) or, for example, summarily in a histogram whose bins correspond to the schemes of the catalog and that are incremented on each fit of an affected scheme to a read code.

At the end of the teaching phase, the statistic is preferably evaluated to determine the subset of the schemes to be activated, in particular as those schemes that have been detected as matching during the teaching phase with a required relative or absolute frequency. The teaching phase is ended when a criterion such as an overall duration, a number of detected codes in total, a number of successful code reads (GoodReads), or a comparable measure reaches a possibly parameterizable specification. Those schemes that have fit sufficiently frequently in accordance with the statistic are activated; the remaining schemes are or remain deactivated. The frequency can be measured as absolute or relative.

After the teaching phase, a check is preferably furthermore made of which scheme matches a respective read message to continue the statistic or to generate a further statistic, with at least one scheme being subsequently activated at least at least one scheme being deactivated after evaluation of the continued or further statistic. In this embodiment, an evaluation analogous to the teaching phase of which schemes of the catalog best match the current application situation furthermore takes place in parallel after the end of the teaching phase. It is thereby possible to react to changes such as a batch change. Schemes that no longer match are then deactivated or new matching schemes are now activated. It is conceivable to detect different statistics or a plurality of histograms to be able to distinguish the statistics of the teaching phase and the later phases. Alternatively, datasets such as (point in time; message; matching scheme) can be associated according to their time stamps and can have more or less weight depending on their age up to the point that the datasets are discarded age onward. A further alternative is a type of floating mean value of the number of matches per scheme over time that likewise results in a forgetting.

A non-matching number of how often no scheme of the catalog matches a message of a read code is preferably detected during the teaching phase and/or after the teaching phase. This is naturally not useful with respect to an activation of schemes since there is actually no matching scheme for these cases. The number of codes that no scheme at all matches can nevertheless be helpful information, for example for the determination of relative frequencies. It can be managed as a further bin of a histogram.

All the schemes are preferably deactivated if the non-matching number exceeds a minimum frequency. This is a further possible consequence from the number of codes which no scheme matches. If this occurs too often, it is concluded in this embodiment that the whole catalog of schemes is not properly suitable for the given application situation. More damage than use is then expected from the application of the schemes and the comparison and the correction with schemes is fully deactivated. This can be associated with a message to the user, simply as information or, for example, with the aim of replacing or improving the catalog. The minimum frequency can in turn be specified absolutely or relatively.

At least one scheme preferably triggers an additional function if it is recognized as matching the message. Certain types of codes that possibly have very individual properties or carry additional information can also be recognized via the scheme. The matching of a scheme can then trigger an additional function to satisfy these propertied or to continue to use the properties. Such additional functions can be bound to a scheme as rules or program modules and are then automatically triggered when the scheme matches a currently read code.

The additional function preferably has optical character recognition that reads a text associated with the optical code, in particular a check digit, that is only included in clear text, but not as part of the message encoded in the optical code in the image data. In this case, the scheme belongs to a family of codes that are typically printed together with a clear text, with the clear text containing information that goes beyond the encoded message. An example is an additional check digit printed in clear text. The additional function here is optical character recognition (OCR) by which additional clear text can be detected. The clear text can then simply also be output. In the case of a check digit, the additional function can also carry out an associated further consistency check.

The additional function preferably has a country code recognition, in particular with a proposal for a matching country code to a user. Country codes are insufficiently defined in a scheme as variable characters or letters because by no means all the letter tuples correspond to a permitted country code. The additional function can therefore carry out a more precise comparison with a country table, for example. In the event of an incompletely read country code, further heuristics can be added between a plurality of conceivable additions to an authorized country code. It is thus more likely that a neighboring country was encoded as a remote country or an important trading partner is more likely than an economically insignificant microstate.

The optoelectronic code reader in accordance with the invention has a light reception element to generate image data from received light and thus to record an image. The light receiver can be that of a barcode scanner, for example a photodiode, and the intensity profiles of the scans are assembled line-wise to form the output Image. It is preferably an image sensor of a camera-based code reader. The image sensor can in turn be a line sensor for the detection of a code line or of an areal code image by assembling image lines or a matrix sensor, with recordings of a matrix sensor also being able to be assembled to form a larger image. A network of a plurality of code readers or camera heads is likewise conceivable. A method in accordance with the invention of reading optical codes in accordance with one of the embodiments is then implemented in a control and evaluation unit that can itself be part of a barcode scanner or of a camera based code reader or can be connected thereto as a control device.

The invention will be explained in more detail in the following also with respect to further features and advantages by way of example with reference to embodiments and to the enclosed drawing. The Figures of the drawing show in:

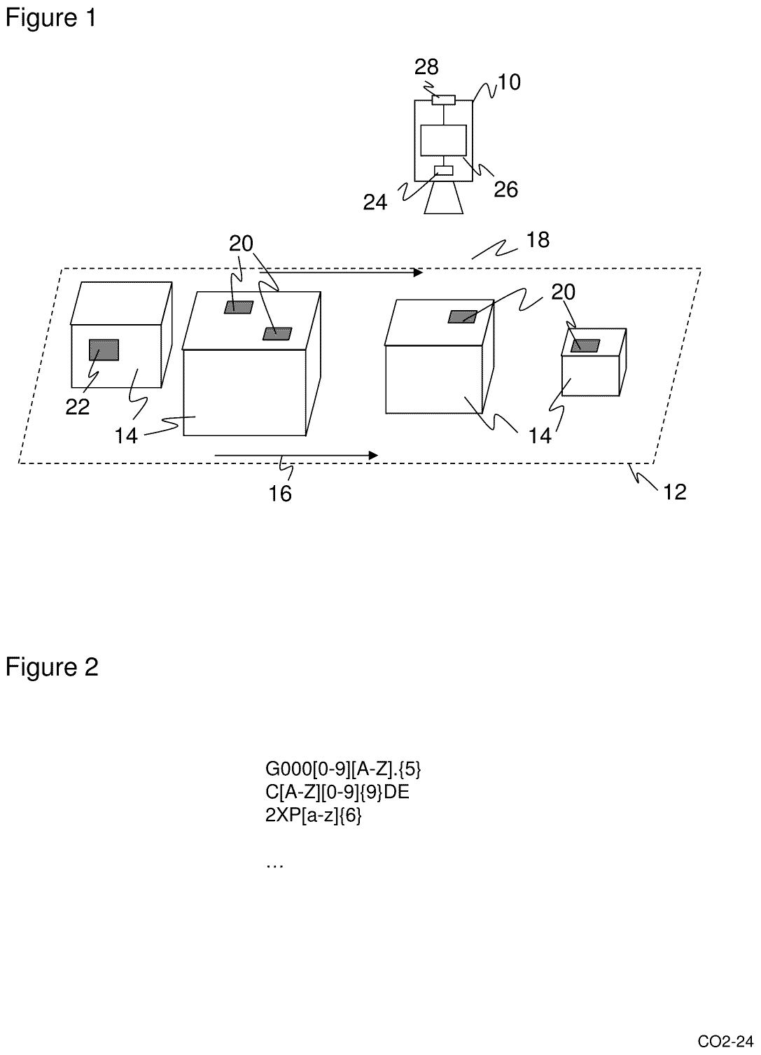

FIG. 1 a schematic overview representation of a code reader that is installed by way of example above a conveyor belt on which objects having optical codes to be read are conveyed;

FIG. 2 some exemplary schemes;

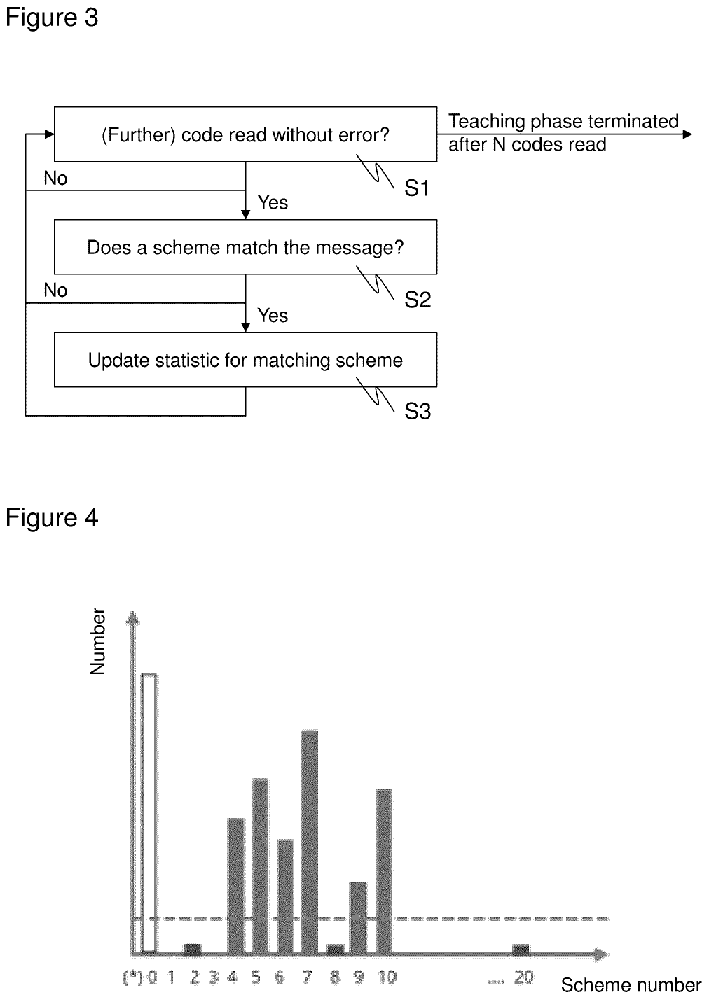

FIG. 3 an exemplary flowchart for a teaching phase in which a statistic on schemes matching the codes to be read is generated; and

FIG. 4 an exemplary histogram as a result of the teaching phase that is evaluated to activate the schemes that match and that are to be activated for the further code reading.

FIG. 1 shows an optoelectronic code reader 10 that is mounted above a conveyor belt 12 which conveys objects 14 through the detection zone 18 of the code reader 10, as indicated by the arrow 16. The objects 14 bear code zones 20 on their outer surfaces that are detected and evaluated by the code reader 10. These code zones 20 can only be recognized by the code reader 10 when they are affixed to the upper side or at least in a manner visible from above. Differing from the representation in FIG. 1, a plurality of code readers 10 can be installed from different directions for the reading of a code 22 affixed somewhat to the side or to the bottom in order to permit a so-called omnireading from all directions. The arrangement of the plurality of code readers 10 to form a reading system mostly takes place as a reading tunnel in practice. This stationary use of the code reader 10 at a conveyor belt is very common in practice. The invention, however, relates to the reading of codes or to the code reader 10 itself so that this example may not be understood as restrictive. Codes can also be scanned by hand, for example, or a code or an object 14 having a code can be held in the reading field of the code reader 10 in a presentation application.

The code reader 10 detects image data of the conveyed objects 14 and of the code zones 20 by a light receiver 24 and said image data are further processed by a control and evaluation unit 26 by means of image evaluation and decoding processes. The control and evaluation unit 26 comprises, for example, at least one processing module such as a microprocessor or a CPU (central processing unit), an FPGA (field programmable gate array), a DSP (digital signal processor), an ASIC (application specific integrated circuit), an AI processor, an NPU (neural processing unit), a GPU (graphics processing unit), a VPU (video processing unit), or the like. It is not the specific imaging process that is furthermore important to the invention so that the code reader 10 can be set up in accordance with any principle known per se. For example, only one respective line is detected, either by means of a linear image sensor or by means of a scanning process, and the control and evaluation unit assembles the lines detected in the course of the conveying movement to form the image data. A larger zone can already be detected in a recording using a matrix-like image sensor, with the assembly of recordings here also being possible both in the conveying direction and transversely thereto. The central function of the code reader 10 is the decoding, i.e. the reading of the message encoded in an optical code as clear text. The message is a character chain of utility characters, preferably with at least one check character that is typically at the end. The code reader 10 outputs information such as messages read from the codes or image data via an interface 28.

A correction of the respective message read from a code by means of schemes will be explained in the following with reference to FIGS. 2 to 4. It is preferably carried out in the control and evaluation unit 26. It is, however, equally conceivable to output image data or intermediate results via the interface 28 and to outsource at least some of the decoding, and/or correction to a higher ranking system such as a control processor, a network, or a cloud. Pre-processing of the image data for segmentation and for localizing code zones 20 and the decoding per se are assumed as known and not described.

FIG. 2 shows some exemplary schemes that can be used to correct a message read from an optical code 20. They are formulated as regular expressions here. “G000” are expected by the first scheme as the first four fixed characters in accordance with the convention underlying the scheme here. Two variable characters follow, namely a numeral and an upper case letter and then a further five arbitrary characters symbolized above the dot. The second scheme accordingly first requires the upper case letter C as fixed, then an arbitrary upper case letter, nine numerals, and finally the fixed upper case letters DE. The third scheme starts with the fixed characters 2XP followed by six lower case letters. Further conceivable schemes comprise a fixed portion having more or fewer characters, contiguously or distributed at the start, end, or at the middle in the scheme and no or another variable portion and other variations. The syntactic convention is likewise purely exemplary; the specifications of the fixed portion and/or variable portion can be noted in any desired manner. Reference is again additionally made to EP 4 258 160 A1 with reference to the possible embodiments of a scheme and its application to a code.

A plurality of the schemes shown by way of example here are available in a catalog as the starting point for the process now to be described. How these schemes of the catalog are acquired is not the subject matter of this invention. They can be acquired manually from general considerations, code specifications, or logfiles of code readers or it is done at least in a supporting or fully automatic manner based on computer evaluations of histories of read codes in which regularities have been recognized. The schemes of the catalog can be verified and tested so that they are at least syntactically in agreement and where possible form a pool for codes relevant in the field. Different catalogs can be formed for differently typical application scenarios. An identification such as a unique number or a name is preferably associated with each scheme to be able to associate the schemes.

It is a great advantage of predefined schemes of the catalog, beside the correct syntax ensured by an expert, that higher ranking knowledge can enter here that would not be available at all by automated processes or only after a very large number of examples. A first example is represented by ZIP codes as part of the message. They are consequently not only five numerals, there is still the higher ranking and specified condition that the value range is restricted to 01000-99999. A second example is a weighting code, for instance in the value range from 001-300, with every increment corresponding to a 0.1 kg step.

FIG. 3 shows an exemplary flowchart for a teaching phase in which a statistic on schemes matching the codes to be read is generated. As in FIG. 1, objects 14 with codes 20 are presented and the codes 20 are read during the teaching phase. The teaching phase can be prefixed to an actual operation or work is simply carried out in operation for a while without schemes until the teaching phase has been terminated.

In a step S1, it is queried whether the respective next code 20 was able to have been read without error. If this is not the case, this code 20 does not contribute to the teaching and the process returns to step S1. A correction with schemes cannot yet be made at this point in time because no schemes of the catalog have yet been activated.

A check is made in a step S2 whether a scheme of the catalog matches the message read from the code 20. If no scheme is found here, the process again returns to step S1, otherwise a counter for codes 20 is incremented which no scheme of the catalog matches.

In a step S3, the statistic is updated via matching schemes. Statistic means that statistical statements on the frequency of the matching schemes can be derived therefrom. Updated accordingly means that the statistic maps the previous frequencies of the matching schemes. An example for this used in the following is a histogram that has a bin for every scheme of the catalog. In the step S3, that bin is then incremented that belongs to the matching scheme. If a plurality of matching schemes have been found in step S2, a plurality of bins are fully accordingly incremented.

The process then returns to step S1 again. The teaching phase is ended when a specified number N of codes 22 were able to be read, alternatively when N codes 22 have been evaluated, independently of the reading success, or when a specific duration has elapsed, with these alternative conditions not equally ensuring the breadth of the statistic. Instead of forming a histogram, a plurality of histograms can also be generated to distinguish time phases and to then give greater weight, for example, to more current data or a type of floating mean value can be formed. Data points can also initially simply be collected, in particular with time stamps, which matching schemes have been found to combine these to a statistic later in the evaluation.

FIG. 4 shows an exemplary histogram as a result of the teaching phase that is evaluated to activate the schemes that match and that are to be activated for the further code reading. A frequency threshold is drawn by a dashed line that filters those bins and thus schemes that matched frequently enough during the teaching phase to now activate them. Alternatively, a different measure can be used such as a relative frequency threshold.

The schemes recognized as having occurred sufficiently frequently from the histogram or generally from the statistic are now activated for the further operation. If a code 20 can now not be read, the partially read message is compared with the activated schemes and is then corrected using the scheme if a scheme has been found. A read code can be subjected to additional checks based on the scheme or further information on the code and/or message can be derived from the scheme. Reference is here again made to EP 3 428 835 B1 and to EP 4 258 160 A1.

It is conceivable to continue to keep or to rebuild a statistic during operation with activated schemes in the background analogously to the teaching phase of which schemes of the catalog, i.e. of the activated and non-activated schemes, match the read codes 20. If sufficient cases have arisen here, for example N read codes again analogous to the teaching phase, an evaluation can again be made as in FIG. 4 to subsequently activate schemes that could now be associated sufficiently frequently or to deactivate those schemes that no longer occur so frequently. An adaptation to changing application conditions is thereby made possible.

An optional zeroth bin is shown in FIG. 4 that is not associated with any scheme, but has rather counted how often none of the schemes of the catalog have matched a read code 20. This zeroth bin will often have the largest number, indeed also more dramatically than in FIG. 4. It is initially simply completing additional information. It is, however, also conceivable to use the number in the zeroth bin as the criterion of whether schemes of the current catalog should be activated at all. If this number exceeds a certain frequency, for example 90% of the total codes considered in the histogram, it must be assumed that the catalog is not easily suitable for the application situation, with the result that all the schemes are deactivated or the checking and correction functionality based thereon is switched off in total or remains.

Schemes can define an additional function as a further option. If a scheme is then associated with a read code in operation, the additional function of the matching scheme can also be carried out in addition to the checks and corrections. An example for an additional function is the switching in of special decoder modules, for instance a pattern recognition, in particular on certain portions of the code or optical character recognition to read a text associated with the code. Another example is a special check that cannot be parsed in regular expressions.

As an even more specific example, there are codes for which a clear text has been printed that goes beyond the message of the code itself and, for example, contains a further check digit. If such a code is recognized based on a match of a corresponding scheme, its additional function can read the further check digit by means of optical character recognition. The message can then be verified again by the further check digit. This is particularly advantageous when a check digit of the code itself has already been used to correct a reading error. Alternatively or additionally, the further check digit is output as additional information with the message.

A further example is a country code and an additional function that checks or corrects this country code. This is generally a combination of two upper case letters and is recognizable as such by corresponding variable characters of a scheme. However, all the pairs of upper case letters are by no means a country code. The additional function of a corresponding scheme with a country code can thus make use of a country code table to check or correct a country code. Special heuristics and measures are also conceivable here. For example, distances between the installation location of the code reader and the presumed country code and/or from priorities of the countries from the application viewpoint ae used, for instance a frequency of how often countries occurred in the previously read codes. The presumption of the additional function would then tend more to an important neighboring country than to an unimportant remote country. It is conceivable as a further alternative to return very directly with the country codes still coming into question to their location in the image data and, for example, to still detect the country code based on a pattern comparison. Since the country code has great importance in a logistics application, the event of the additional function is preferably only proposed and is not automatically corrected so that a subsequent manual control is made possible that avoids coarse association errors.

1. A method of reading an optical code that encodes a message that has a character chain having a plurality of characters, said method comprising the steps
recording image data having the optical code;
evaluating the image data by reading the message;
comparing the read characters of the message with at least one scheme that contains a character for at least one position of the message that is expected at this position in codes to be read; and
checking or correcting the read message based on a scheme matching the message after the comparison,
wherein a prefabricated catalog of schemes is provided; and wherein a subset of the schemes of the catalog is activated for the comparison with the read characters of the message.

2. The method in accordance with claim 1,
wherein the scheme has a code length and/or contains a fixed character or a variable character for every position.

3. The method in accordance with claim 2,
wherein a scheme has at least one of the following partial regions of the possible characters of a variable character: non-printable characters, special characters, numerals, letters, lower case letters, upper case letters, in particular by ASCII codes.

4. The method in accordance with claim 1,
wherein a scheme is formulated as a regular expression that indicates the permitted characters for the respective positions.

5. The method in accordance with claim 1,
wherein the schemes of the subset are activated in a teaching phase.

6. The method in accordance with claim 5,
wherein, when a message of an optical code was able to be read, a comparison of the read characters of the message with the schemes of the catalog takes place to determine which scheme matches the read message and a statistic is built up from the matching messages.

7. The method in accordance with claim 6,
wherein the statistic is a histogram that collects the frequencies of the matching messages.

8. The method in accordance with claim 6,
wherein at the end of the teaching phase, the statistic is evaluated to determine the subset of the schemes to be activated.

9. The method in accordance with claim 8,
wherein the statistic is evaluated to determine the subset as those schemes that have been detected as matching during the teaching phase with a required relative or absolute frequency.

10. The method in accordance with claim 8,
wherein after completion of the teaching phase, a check is furthermore made of which scheme matches a respective read message to continue the statistic or to generate a further statistic; and wherein at least one scheme is subsequently activated and/or at least one scheme being deactivated after evaluation of the continued or further statistic.

11. The method in accordance with claim 5,
wherein a non-matching number of how often no scheme of the catalog matches a message of a read code is detected during the teaching phase and/or after the teaching phase.

12. The method in accordance with claim 11,
wherein all the schemes are deactivated when the non-matching number exceeds a minimum frequency.

13. The method in accordance with claim 1,
wherein at least one scheme triggers an additional function if it is recognized as matching the message.

14. The method in accordance with claim 13,
wherein the additional function has optical character recognition that reads a text associated with the optical code that is only included in clear text, but not as part of the message encoded in the optical code in the image data.

15. The method in accordance with claim 14,
wherein the text associated with the optical code is a check digit.

16. The method in accordance with claim 13,
wherein the additional function has a country code recognition.

17. The method in accordance with claim 16,
wherein the additional function has a country code recognition with a proposal for a matching country code to a user.

18. An optoelectronic code reader having at least one light reception element for generating image data from received light and having a control and evaluation unit in which a method of reading optical codes is implemented, said method comprising the steps
recording image data having the optical code;
evaluating the image data by reading the message;
comparing the read characters of the message with at least one scheme that contains a character for at least one position of the message that is expected at this position in codes to be read; and
checking or correcting the read message based on a scheme matching the message after the comparison,
wherein a prefabricated catalog of schemes is provided; and wherein a subset of the schemes of the catalog is activated for the comparison with the read characters of the message.
